(19) United States
(12) Patent Application Publication
(10) Pub. No.: US 2009/0083571 A1
(43) Pub. Date: Mar. 26, 2009

(54) SYSTEM ON CHIP WITH LOW POWER MODE AND METHOD OF DRIVING THE SAME

(75) Inventors: Koon Shik Cho, Suwon (KR); Seung Han Ko, Sungnam (KR); Jae Hyung Lee, Suwon (KR); Sang Ho Lee, Suwon (KR); Kwang Mook Lee, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Suwon (KR)

(21) Appl. No.: 12/104,956

(22) Filed: Apr. 17, 2008

(30) Foreign Application Priority Data
Sep. 20, 2007 (KR) 10-2007-0096065

(51) Int. Cl. G06F 1/04

(52) U.S. Cl. 713/601

(57) ABSTRACT

There are provided a system on chip (SoC) with a low power mode and a method of driving the SoC, the SoC including: a power part supplying a main clock signal and controlling analog and digital power supply at a normal mode and supplying a sub clock signal and turning analog power off at a low power mode; a radio frequency (RF) part generating the main clock signal at the normal mode and stopping operation at the low power mode, under the control of the power part; and a control part operating according to the main clock signal at the normal mode and operating according to the sub clock signal, under to the control of the power part.

### CROSS-REFERENCE TO RELATED APPLICATIONS

This application claims the priority of Korean Patent Application No. 2007-0096065 filed on Sep. 20, 2007, in the Korean Intellectual Property Office, the disclosure of which is incorporated herein by reference.

### BACKGROUND OF THE INVENTION

1. Field of the Invention

The present invention relates to a system on chip (SoC) with a low power mode and a method of driving the same, and more particularly, to an SoC with a low power mode and a method of driving the SoC, the SoC capable of operating according to a sub clock signal of a lower frequency than that of a main clock signal and simultaneously with including the low power mode turning a radio frequency (RF) part off to notably reducing power consumption.

2. Description of the Related Art

Recently, due to development of Ubiquitous, there are performed researches on system on chip (SoC) performing an independent function on one semiconductor, such as wireless personal area network (WPAN), ultra wideband (UWB), or radio frequency identification (RFID).

Such SoC includes a modem to communicate with an external device, a memory to store data, a central processing unit (CPU) that is a main processing device for the SoC, and a peripheral block. Accordingly, for miniaturization and low power consumption, it becomes very important to reduce power consumption.

FIG. 1 is a block diagram illustrating a conventional SoC 10.

Referring to FIG. 1, the SoC 10 includes a regulator 11, a clock generator 12, a CPU 13, a direct memory access (DMA) 14, a memory 15, a peripheral block 16, a modem 17, a mode controller 18, and a plurality of AND gates AND1 to AND4.

The regulator 11 is connected to all elements of the SoC 10, generates a power voltage Vin to drive the SoC 10, and supplies the power voltage to all of the elements of the SoC 10.

The clock generator 12 generates a clock to drive all of the elements of the SoC 10 together with the power voltage Vin supplied from the regulator 11 and supplies the clock to each of the elements of the SoC 10.

The CPU 13 is a main processing device controlling the SoC 10. The DMA 14 is connected to all of the elements of the SoC 10 and controls input and output thereof. Also, the peripheral block 16 is connected to peripheral devices around the SoC 10. The modem wirelessly communicates with an external device.

In this case, to reduce power consumption of the SoC 10 according to a present operation status of the SoC 10, the mode controller 18 should be capable of controlling operations at a low power mode distinguished from a normal mode.

In the conventional SoC 10, one of an active mode and a stop mode is selected in such a way that it is possible to reduce power consumption by stopping unnecessary operation when the operation is not required.

However, in the case of the active mode of the SoC 10, though there is present a case in which operation of an RF part is unnecessary in a certain situation, an unnecessary circuit part is always operated. Accordingly, power is wasted in the active mode.

### SUMMARY OF THE INVENTION

An aspect of the present invention provides a system on chip (SoC) with a low power mode and a method of driving the SoC, the SoC capable of notably reducing power consumption by including the low power mode of operating according to a sub clock signal with a lower frequency than that of a main clock signal simultaneously with turning an RF part off.

According to an aspect of the present invention, there is provided an SoC with a low power mode, the SoC including: a power part supplying a main clock signal and controlling analog and digital power supply at a normal mode and supplying a sub clock signal and turning analog power off at a low power mode; a radio frequency (RF) part generating the main clock signal at the normal mode and stopping operation at the low power mode, under the control of the power part; and a control part operating according to the main clock signal at the normal mode and operating according to the sub clock signal, under to the control of the power part.

The power part may include: a power controller controlling the supply of the main clock signal together with the supply of the analog and digital power at the normal mode and controlling the supply of the sub clock signal together with turning the analog power off at the low power mode; a sub clock generator generating the sub clock signal; and a clock selector selecting the main clock signal at the normal mode, selecting the sub clock signal at the low power mode, and supplying the selected one to the control part.

The sub clock generator may generate the sub clock signal having a lower frequency than that of the main clock signal.

The RF part may include: an analog regulator operating under the control of the power part; a main clock generator generating the main clock signal according to an operation voltage from the analog regulator; and an RF transceiver transmitting and receiving a preset RF signal.

The control part may include: a digital regulator operating under the control of the power part; a main controller operating according to the main clock signal at the normal mode and operating according to the sub clock signal at the low power mode, under the control of the power part; and an interface connected to the main controller and processing data transfer with an external peripheral device.

According to another aspect of the present invention, there is provided a method of driving an SoC including a power part, an RF part, and a control part, the method including: performing, at the power part, a normal mode comprising selecting a main clock signal generated at the RF part, supplying the selected main clock signal to the control part, and supplying power to the RF part and the control part; determining whether a low power mode is selected and performing the normal mode when the low power mode is not selected; performing, when the low power mode is selected, the low power mode comprising selecting a sub clock signal, supplying the selected sub clock signal to the control part, and stopping power supply of the RF part; and determining whether it is selected to release the low power mode, performing the low power mode when it is selected not to release the low power mode, and performing the normal mode when it is selected to release the low power mode.

The method may further include: determining whether an end is selected when it is selected to release the low power mode; performing the normal mode when the end is not selected; and ending an entire process when the end is selected.

According to an exemplary embodiment of the present invention, it is possible to notably reduce power consumption due to a low power mode of operating according to a sub clock signal with a lower frequency than that of a main clock signal simultaneously with turning an RF part off.

In addition, different from a normal mode, in the low power mode, since the sub clock signal having the lower frequency than that of the main clock signal is used, it is possible to more reduce the power consumption.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating a conventional system on chip (SoC);

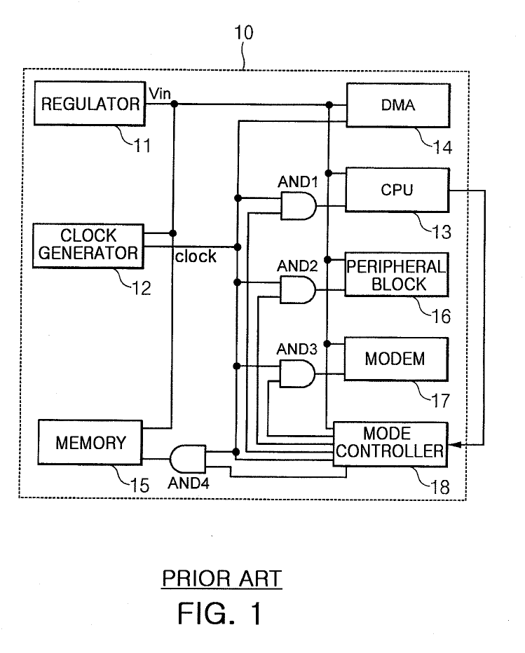

FIG. 2 is a configuration diagram illustrating an SoC with a low power mode, according to an exemplary embodiment of the present invention; and

FIG. 3 is a flowchart illustrating a method of driving the SoC, according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the same reference numerals are used throughout to designate the same or similar components.

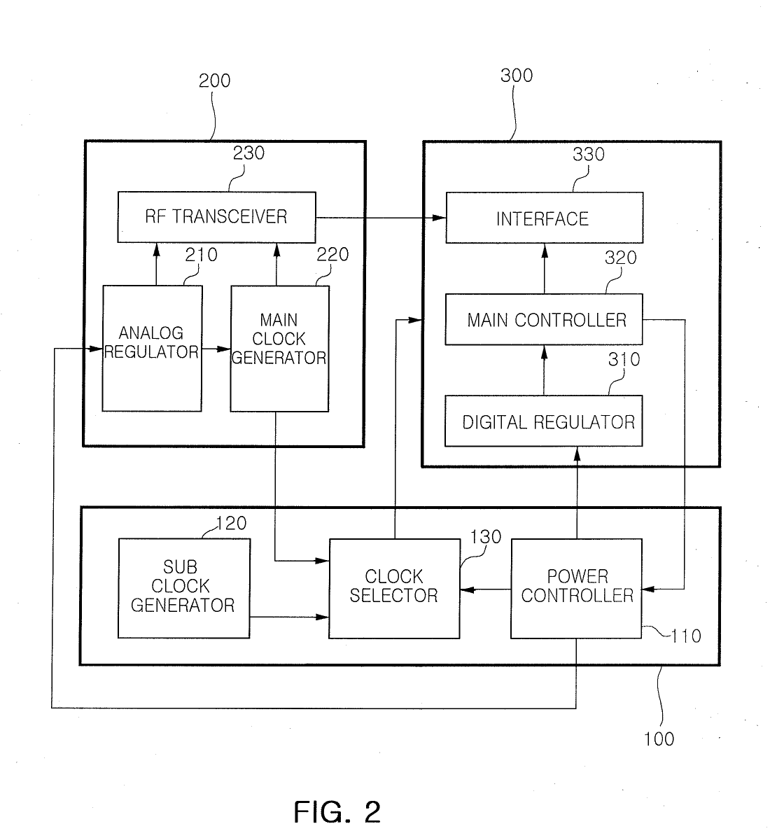

FIG. 2 is a configuration diagram illustrating a system on chip (SoC) with a low power mode, according to an exemplary embodiment of the present invention.

Referring to FIG. 2, the SoC includes a power part 100 supplying a main clock signal and controlling analog and digital power supply at a normal mode and supplying a sub clock signal and turning analog power off at a low power mode, a radio frequency (RF) part 200 generating the main clock signal at the normal mode and stopping operation at the low power mode, under the control of the power part 100, and a control part 300 operating according to the main clock signal at the normal mode and operating according to the sub clock signal, under to the control of the power part 100.

The power part 100 includes a power controller 110 controlling the supply of the main clock signal together with the supply of the analog and digital power at the normal mode and controlling the supply of the sub clock signal together with turning the analog power off at the low power mode, a sub clock generator 120 generating the sub clock signal, and a clock selector 130 selecting the main clock signal at the normal mode, selecting the sub clock signal at the low power mode, and supplying the selected one to the control part 300.

The sub clock generator 120 generates the sub clock signal having a lower frequency than a frequency of the main clock signal.

The RF part 200 includes an analog regulator 210 operating under the control of the power part, a main clock generator 220 generating the main clock signal according to an operation voltage from the analog regulator 210, and an RF transceiver 230 transmitting and receiving a preset RF signal.

The control part 300 includes a digital regulator 310 supplying required power to the control part 300, under the control of the power part 100, a main controller 320 operating according to the main clock signal at the normal mode and operating according to the sub clock signal at the low power mode, under the control of the power part 100, and an interface 330 connected to the main controller 320 and processing data transfer with an external peripheral device.

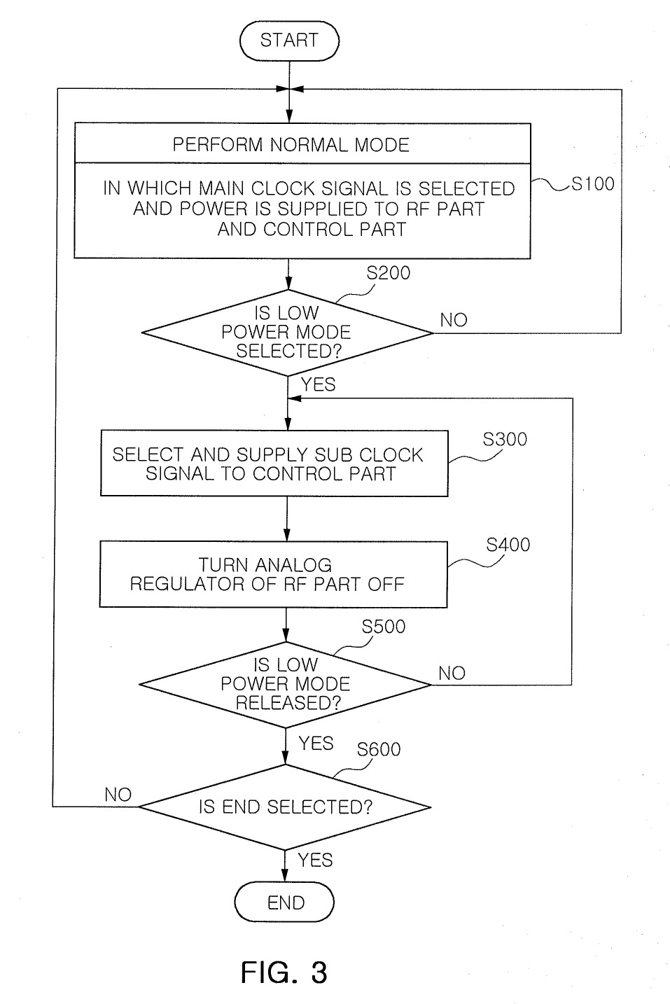

FIG. 3 is a flowchart illustrating a method of driving the SoC of FIG. 2, according to an exemplary embodiment of the present invention.

Referring to FIGS. 2 and 3, the method of driving the SoC including the power part 100, the RF part 200, and the control part includes performing, at the power part 100, a normal mode including selecting a main clock signal generated at the RF part 200, supplying the selected main clock signal to the control part 300, and supplying power to the RF part 200 and the control part 300 (S100), determining whether a low power mode is selected and performing the normal mode when the low power mode is not selected (S200), performing, when the low power mode is selected, the low power mode including selecting a sub clock signal, supplying the selected sub clock signal to the control part 300, and turning power supply of the analog regulator 210 of the RF part 200 off (S300 and S400), and determining whether it is selected to release the low power mode, performing the low power mode when it is selected not to release the low power mode, and performing the normal mode when it is selected to release the low power mode (S500).

The method may further include determining whether an end is selected when it is selected to release the low power mode, performing the normal mode when the end is not selected, and ending an entire process when the end is selected (S600).

Hereinafter, operations and effects of the present invention will be described in detail.

Referring to FIGS. 2 and 3, the SoC with the low power mode and the method of driving the SoC will be described.

Referring to FIG. 2, the SoC includes the power part 100, the RF part 200, and the control part 300.

When the SoC is in a normal mode, the power part 100 supplies a main clock signal to the control part 300, controls analog power supply to the RF part 200, and controls digital power supply to the control part 300.

The RF part 200, at a normal mode, operates and generates the main clock signal, under the control of the power part 100.

The control part 300 operates according to the main clock signal at the normal mode, under to control of the power part 100.

When the SoC is in a low power mode, the power part 100 supplies a sub clock signal to the control part 300 and turns analog power of the RF part 200 off.

The RF part 200 stops operation at the low power mode, under the control of the power part 100.

The control part 300 operates according to the sub clock signal at the low power mode.

The power part 100 may include the power controller 110, the sub clock generator 120, and the clock selector 130.

At the normal mode, the power controller 110 controls a supply of the main clock signal, controls analog power supply to the RF part 200, and controls digital power supply to the control part 300.

The sub clock generator 120 generates the sub clock signal having a lower frequency than a frequency of the main clock signal.

In this case, the clock selector 130, at the normal mode, selects the main clock signal and supplies the selected main clock signal to the control part 300, under the control mode of the power controller 110.

At the low power mode, the power controller 110 controls a supply of the sub clock signal and turns power of the RF part off.

The clock selector 130 selects the sub clock signal and supplies the selected sub clock signal to the control part 300, under the control of the power controller 110.

The RF part 200 may include the analog regulator 210, the main clock generator 220, and the RF transceiver 230.

At the normal mode, the analog regulator 210 operates under the control of the power part 100 and supplies power required for operation of the RF part 200. The main clock generator 220 operates according to an operation voltage from the analog regulator 210 and generates the main clock signal. The RF transceiver 230 transmits and receives a preset RF signal according to the main clock signal.

At the low power mode, since the analog regulator 210 stops operation, the RF part 200 stops operation.

The control part 300 may include the digital regulator 310, the main controller 320, and the interface 330.

In this case, the digital regulator 310 operates under the control of the power part 100 and supplies power required for operation of the control part 300.

At the normal mode, the main controller 320 operates according to the main clock signal, under the control of the power part 100.

At the low power mode, the main controller 320 operates according to the sub clock signal.

Also, at the normal mode and the low power mode, the interface 330 is connected the main controller 320 and process data transfer with external peripheral devices.

In this case, as the interface 330 for data transfer with the external peripheral devices, there are universal asynchronous receiver transmitter (UART), 12C (I-square-C) that is bidirectional serial bus standards, and a serial peripheral interface (SPI) corresponding to synchronous serial communication.

Referring to FIGS. 2 and 3, the method of driving the SoC according to an exemplary embodiment of the present invention will be described.

Referring to FIG. 2, the SoC includes the power part 100, the RF part 200, and the control part 300. The method of driving the SoC will be described.

Referring to FIG. 3, in S100, the power part 100 operates to perform a normal mode in which a main clock signal generated by the RF part 200 and supplied to the control part 300 and power is supplied to the RF part 200 and the control part 300.

In S200, it is determined whether a low power mode is selected. When the low power mode is not selected, the normal mode is performed.

In S300 and S400, when the low power mode is selected, a sub clocks signal is selected and supplied to the control part 300 and power supply to the RF part is stopped.

In S500, it is determined whether it is selected to release the low power mode. When it is selected not to release the low power mode, the low power mode is performed. When it is selected to release the low power mode, the normal mode is performed.

Also, in S600, when the method further includes determining whether to end an overall process while it is determined whether to release the low power mode, it is determined to select the end when it is selected to release the low power mode. When the end is not selected, the normal mode is performed. When the end is selected, the overall process is finished.

As described above, the description on the SoC according to an exemplary embodiment of the present invention is applied to the method of driving the SoC according to an exemplary embodiment of the present invention, as it is. Accordingly, a more detailed description on the SoC applied to the method of driving the SoC will be omitted.

While the present invention has been shown and described in connection with the exemplary embodiments, it will be apparent to those skilled in the art that modifications and variations can be made without departing from the spirit and scope of the invention as defined by the appended claims.

What is claimed is:

1. A system on chip (SoC) with a low power mode, the SoC comprising:
a power part supplying a main clock signal and controlling analog and digital power supply at a normal mode and supplying a sub clock signal and turning analog power off at a low power mode;
a radio frequency (RF) part generating the main clock signal at the normal mode and stopping operation at the low power mode, under the control of the power part; and
a control part operating according to the main clock signal at the normal mode and operating according to the sub clock signal at a low power mode, under to the control of the power part.

2. The SoC of claim 1, wherein the power part comprises:
a power controller controlling the supply of the main clock signal together with the supply of the analog and digital power at the normal mode and controlling the supply of the sub clock signal together with turning the analog power off at the low power mode;
a sub clock generator generating the sub clock signal; and
a clock selector selecting the main clock signal at the normal mode, selecting the sub clock signal at the low power mode, and supplying the selected one to the control part.

3. The SoC of claim 2, wherein the sub clock generator generates the sub clock signal having a lower frequency than that of the main clock signal.

4. The SoC of claim 1, wherein the RF part comprises:
an analog regulator operating under the control of the power part;
a main clock generator generating the main clock signal according to an operation voltage from the analog regulator; and
an RF transceiver transmitting and receiving a preset RF signal.

5. The SoC of claim 1, wherein the control part comprises:
a digital regulator operating under the control of the power part;
a main controller operating according to the main clock signal at the normal mode and operating according to the sub clock signal at the low power mode, under the control of the power part; and
an interface connected to the main controller and processing data transfer with an external peripheral device.

6. A method of driving an SoC comprising a power part, an RF part, and a control part, the method comprising:
performing, at the power part, a normal mode comprising selecting a main clock signal generated at the RF part, supplying the selected main clock signal to the control part, and supplying power to the RF part and the control part;
determining whether a low power mode is selected and performing the normal mode when the low power mode is not selected;
performing, when the low power mode is selected, the low power mode comprising selecting a sub clock signal, supplying the selected sub clock signal to the control part, and stopping power supply of the RF part; and
determining whether it is selected to release the low power mode, performing the low power mode when it is selected not to release the low power mode, and performing the normal mode when it is selected to release the low power mode.

7. The method of claim 6, further comprising:
determining whether an end is selected when it is selected to release the low power mode;
performing the normal mode when the end is not selected; and
ending an entire process when the end is selected.

8. The method of claim 6, wherein the power part controls analog and digital power supply together with supplying the main clock signal at the normal mode and turns analog power off together with supplying the sub clock signal at the low power mode.

9. The method of claim 8, wherein the RF part operates and generates the main clock signal at the normal mode, under the control of the power part.

10. The method of claim 9, wherein the control part operates according to the main clock signal at the normal mode and operates according to the sub clock signal at the low power mode, under the control of the power part.

11. The method of claim 10, wherein the power part comprises:
a power controller controlling the supply of the main clock signal together with the supply of the analog and digital power at the normal mode and controlling the supply of the sub clock signal together with turning the analog power off at the low power mode;
a sub clock generator generating the sub clock signal; and
a clock selector selecting the main clock signal at the normal mode, selecting the sub clock signal at the low power mode, and supplying the selected one to the control part.

12. The method of claim 11, wherein the sub clock generator generates the sub clock signal having a lower frequency than that of the main clock signal.

13. The method of claim 10, wherein the RF part comprises:
an analog regulator operating under the control of the power part;
a main clock generator generating the main clock signal according to an operation voltage from the analog regulator; and
an RF transceiver transmitting and receiving a preset RF signal.

14. The method of claim 10, wherein the control part comprises:
a digital regulator operating under the control of the power part;
a main controller operating according to the main clock signal at the normal mode and operating according to the sub clock signal at the low power mode, under the control of the power part; and
an interface connected to the main controller and processing data transfer with an external peripheral device.
